(19) United States
(12) Patent Application Publication
(10) Pub. No.: US 2008/0244104 A1
(43) Pub. Date: Oct. 2, 2008

(54) BUILDING AUTOMATION SYSTEM FIELD DEVICES AND ADAPTERS

(75) Inventor: Joel C. Clemente, Mequon, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/056,079

(22) Filed: Mar. 26, 2008

Related U.S. Application Data
(60) Provisional application No. 60/920,519, filed on Mar. 28, 2007.

(51) Int. Cl. G06F 3/00

(52) U.S. Cl. 710/11

(57) ABSTRACT

A field device for use in a communicating with a building automation system field controller via a field cable is disclosed. The field device includes an integrated circuit. The integrated circuit includes communications circuitry and sensing circuitry. The integrated circuit is configured to convert a first signal from the sensing circuitry to a second signal compatible with the communications circuitry. The interface is configured to communicatively couple the field cable to the communications circuitry.

### CROSS-REFERENCE TO RELATED PATENT APPLICATIONS

The present application claims the benefit of U.S. Provisional Patent Application No. 60/920,519, filed Mar. 28, 2007, the entire disclosure of which is incorporated by reference.

### BACKGROUND

The application generally relates to building automation systems. The application relates more specifically to field communication bus components for use with building automation systems.

Building automation systems are often employed in buildings such as office buildings, schools, manufacturing facilities, and the like, for controlling the internal environment of the facility. Building automation systems may be employed to control temperature, air flow, humidity, lighting, energy, boilers, chillers, power, security, fluid flow, and similar building systems relating to the environment of the building. Some building automation systems include heating, ventilation, and/or air conditioning (“HVAC”) systems. HVAC systems commonly seek to provide thermal comfort, acceptable air quality, ventilation, and controlled pressure relationships to building zones. HVAC systems typically include an HVAC control system and one or more ventilation devices such as air handling units and variable air volume boxes.

Building automation system components may be autonomous or interconnected to form an integrated and/or distributed system. Interconnected building automation systems typically include a number of components distributed around a building or building zone. While some building automation systems are wireless, many are wired. As controller processing power increases, building automation professionals are able to install more sophisticated building automation systems, including building automation systems having an increased number of end devices or sensors. While a greater number of sensors and/or other wired building automation components may help provide building automation professionals with an increased amount of information about a building zone or component of interest, the number of these devices may also present a number of challenges. These challenges may be installation-related, power-related, and/or cost related.

In a building automation system, devices such as sensors are typically connected to an intermediate level controller such as a field controller. The sensors are usually distributed around a zone and may be wired in series or parallel to the field controller. Because reliability and serviceability are typically highly desirable in a building automation system context, the communications methods and components used throughout the system typically conform to a variety of proprietary or standard device specifications. Some of these standards may relate to the electrical bus or communications bus used to interconnect building automation system components. For example, a variety of traditional field bus specifications and conforming devices exist for interconnecting field controllers and building automation devices such as sensors. These traditional field buses often require the end device to include a relatively complicated electrical circuit that facilitates and supports the communications and processing tasks necessary to communicate with the field controller via the field bus. For example, a typical field bus specification such as a Sensor/Actuator Bus (“SA Bus”) or “Zone Bus” specification may require that the end device include one or more op-amps, one or more precision resistors, one or more microcontrollers, one or more line drivers, one or more pull-up resistors, one or more decoupling caps, and typically a variety of power supply components. Such a component set may result in a larger end device and/or greater electrical draw than may be desirable. The size of the device and/or the inclusion of the number of components in the end device may limit installation options and raise the cost of the device. Furthermore, if the number of end devices such as sensors is large, the cost of the interconnecting wire itself may be high.

It would be desirable to provide a building automation system field bus that allows end devices to include a smaller number of components than typical building automation system field buses. It would further be desirable to provide a building automation system field bus that can power end devices without sacrificing significant wiring distance, number of nodes, and/or bus speed. It would further be desirable to provide a field bus that would facilitate and power smaller end devices than traditional field buses. It would further be desirable to provide a field bus that would allow interconnecting wires or cabling of relatively small gauge sizes.

### SUMMARY

The invention relates to a field device for communicating with a building automation system field controller via a field cable. The field device includes an integrated circuit. The integrated circuit includes communications circuitry and sensing circuitry. The integrated circuit is configured to convert a first signal from the sensing circuitry to a second signal compatible with the communications circuitry. The interface is configured to communicatively couple the field cable to the communications circuitry.

The invention further relates to a sensing system for use with a building automation system field controller. The sensing system includes a device including an integrated circuit. The integrated circuit includes communications circuitry and sensing circuitry. The integrated circuit is configured to convert a first signal from the sensing circuitry to a second signal compatible with the communications circuitry. The sensing system further includes an adapter physically separate and remotely located from the device. The device and the adapter are configured for interconnection via a field cable. The adapter is configured to bridge communications between the building automation system field controller and the device.

The invention further relates to a communications adapter for facilitating communication in a building automation system between a supervisory controller and a plurality of field devices. The adapter includes a first interface for communicating with the supervisory controller according to a first communications protocol. The adapter further includes a second interface for communicating with a plurality of field devices via a wired bus according to a second communications protocol. The adapter yet further includes a microcontroller for converting a first signal received at the second interface and according to the second communications protocol to a second signal for providing to the first interface. The second interface and the second communications protocol are compatible with a System Management Bus (SMBus) specification.

The invention further relates to a temperature sensor system for use with a building automation system field controller. The temperature sensor system includes a first adapter configured to convert a second communications protocol to a first communications protocol, the first communications protocol compatible with the building automation system field controller, the second communications protocol according to a specification, the first adapter comprising a microcontroller suitable for serving as a master device according to the specification. The temperature sensor system further includes a first set of temperature sensors configured to be powered by the adapter and connected via a first cable to the first adapter.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying figures, wherein like reference numerals refer to like elements, in which:

FIG. 1 is a perspective view of a building that includes a building automation system, according to an exemplary embodiment;

FIG. 2 is a close-up perspective view of a building zone, according to an exemplary embodiment;

FIG. 3 is a schematic diagram of a building automation system, according to an exemplary embodiment;

FIG. 4 is a block diagram of a sensor array utilizing a building automation system field bus, according to an exemplary embodiment;

FIG. 5 is a block diagram of a field device suitable for use with a building automation system field bus, according to an exemplary embodiment;

FIG. 6 is a block diagram of a master device, according to an exemplary embodiment;

FIG. 7 is a block diagram of a series of wireless adapters, according to an exemplary embodiment;

FIG. 8 is a block diagram of a sensor array, according to an exemplary embodiment; and

FIG. 9 is a view of a temperature map, according to an exemplary embodiment.

### DESCRIPTION

Before turning to the figures which illustrate the exemplary embodiments in detail, it should be understood that the application is not limited to the details or methodology set forth in the following description or illustrated in the figures. It should also be understood that the terminology employed herein is for the purpose of description only and should not be regarded as limiting.

Referring generally to the figures, a building automation system field bus is provided for interconnecting building automation system field controllers (or other supervisory devices) to field devices such as sensors. The end devices may be sensors (or other devices) originally designed for board-to-board (e.g., same-board, surface mount) communications. According to an exemplary embodiment, systems and devices are provided for using the devices in a distributed manner and remotely from the associated controller. Cable-based (e.g., field bus-based) communications are utilized for the communications between the devices and the associated controller.

The cabling for the communications bus between the devices and the associated controller may be new and/or modified for networking the devices (e.g., temperature sensors, humidity sensors, pressure sensors, contact sensors, infrared sensors, motion sensors, etc.). According to an exemplary embodiment, the field bus is a four-wire bus, including a positive supply voltage wire, a ground, a serial data wire, and a clock wire. The field bus is suitable for use with the native protocol of the devices (e.g., a protocol originally designed for board-to-board communications).

According to an exemplary embodiment, an adapter is provided that is compatible with a first building automation system field bus and the field bus for communicating with the devices. According to various exemplary embodiments, the adapter includes a wireless transceiver for facilitating communications between wireless building automation system nodes and the devices coupled to the field bus.

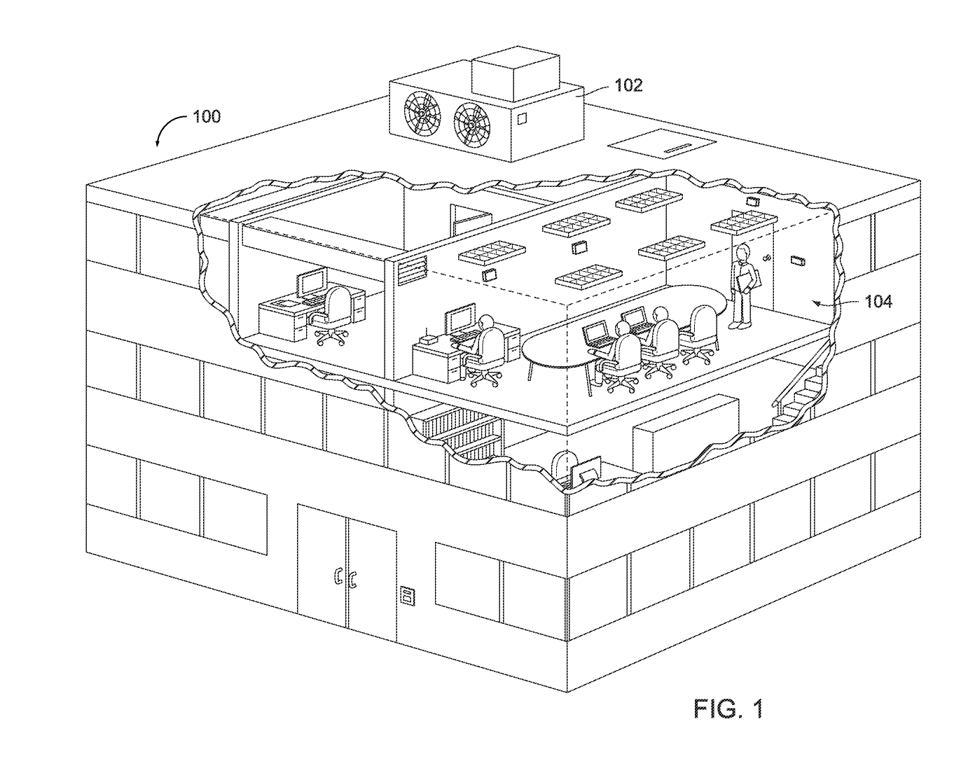

Referring to FIG. 1, a perspective view of an exemplary building 100 that may include a building automation system is illustrated. Building 100 may be a commercial building, an industrial building, an institutional building, a healthcare facility, a school, a manufacturing plant, an office building, a residential building, or any other building that makes use of a building automation system. Building 100 may include one or more air handling units 102, shown in FIG. 1 as a rooftop air handling unit, and one or more building zones 104. As illustrated, building 100 may include any number of floors, rooms, spaces, zones, and/or other building structures and areas, and may house any number of people, lights, and other equipment. Building 100 may be any area of any size or type, including an outdoor area.

Building 100 may include any type or number of HVAC components or devices such as air handling units (e.g., a makeup air unit, a rooftop air unit, a fan coil unit, a constant air volume air handling unit, a variable air volume air handling unit, etc.). Building 100 may also include any type or number of HVAC subsystems and/or HVAC zones. For example, building zone 104 may be an HVAC zone comprising a single room or multiple rooms. In other buildings or systems, each floor of a building may be a separate building zone or HVAC zone controlled by a separate HVAC system, HVAC subsystem, or HVAC component set. Any number of individual heating, cooling, or air control devices may be located around the building and/or each building zone. For example, variable air volume units may be installed throughout building 100. A variable air volume unit or set of variable air volume units may be used by an HVAC control system to regulate the air flow rate and other variables (e.g., heat, humidity, outside air, etc.) provided to the building zone by the HVAC system. Each variable air volume unit may be of any type or design and may include a damper, an actuator, and an actuator control circuit.

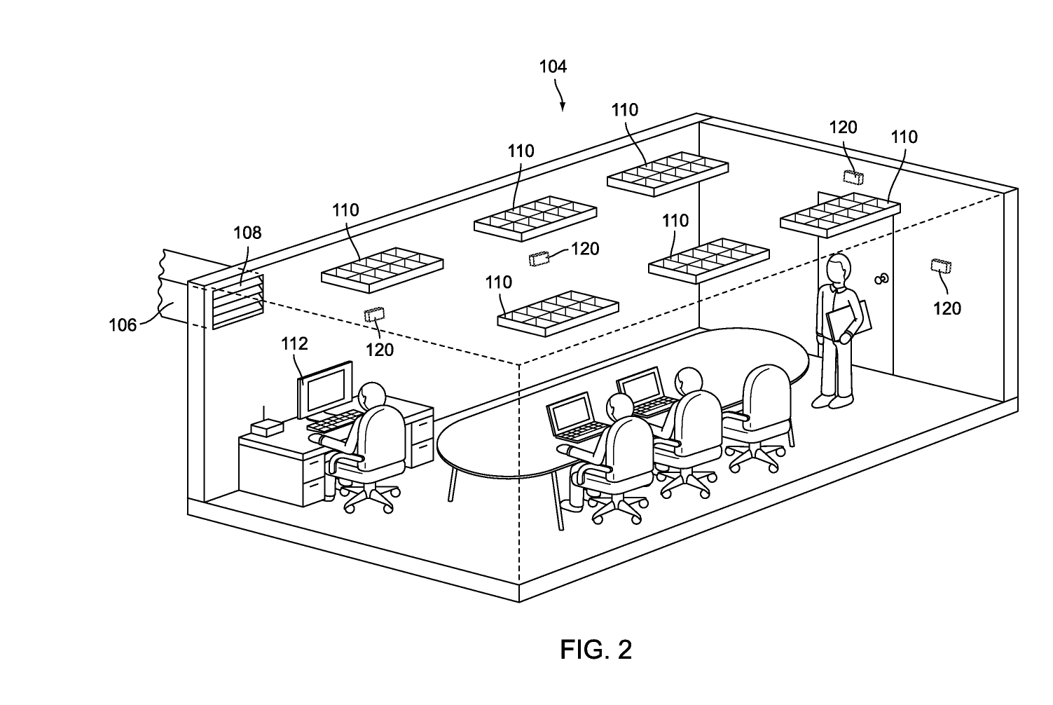

Referring to FIG. 2, a close-up perspective view of a building zone 104 is shown, according to an exemplary embodiment. Building zone 104 may include an HVAC vent 108 coupled to ductwork 106. Supply air flow or ventilation may be provided to zone 104 via vent 108. Building zone 104 may also include lights 110, equipment 112, laptops, people, and sensors 120. Building zone 104 may include any number of additional or alternative objects, equipment, structures, surfaces, people, and/or lights.

Sensors 120 may be located within and/or around building zone 104 and may be configured to sense building conditions or variables of building zone 104. For example, sensors 120 may be temperature sensors, humidity sensors, air quality sensors, equipment sensors, person sensors, lighting sensors, heat transferring object sensors, infrared sensors, RFID transceivers, pressure sensors, CO2 sensors, current sensors, occupancy sensors, motion sensors, and/or any other type of sensor that may be configured to sense a building related condition. Sensors 120 are shown located on the walls of building zone 104, but may be located or positioned in any manner or location within building zone 104. Sensors 120 may also have any number of user interface and/or communications features configured to facilitate their operation with a building automation system. Sensors 120 may be wireless or wired sensors configured to operate on a mesh network or to operate on or with any other network topology. Sensors 120 may also exist in ventilation devices, security devices, fire alarms, controllers, etc. Sensors 120 are shown as having rectangular-shaped housings, but sensors of the system may not be surrounded by housings or may include housings of different shapes and/or sizes.

The building automation system (“BAS”) as illustrated in FIGS. 1-3 is an example of a facility system that may be used in conjunction with the systems and methods of the present disclosure; however, other facility management systems may be used as well.

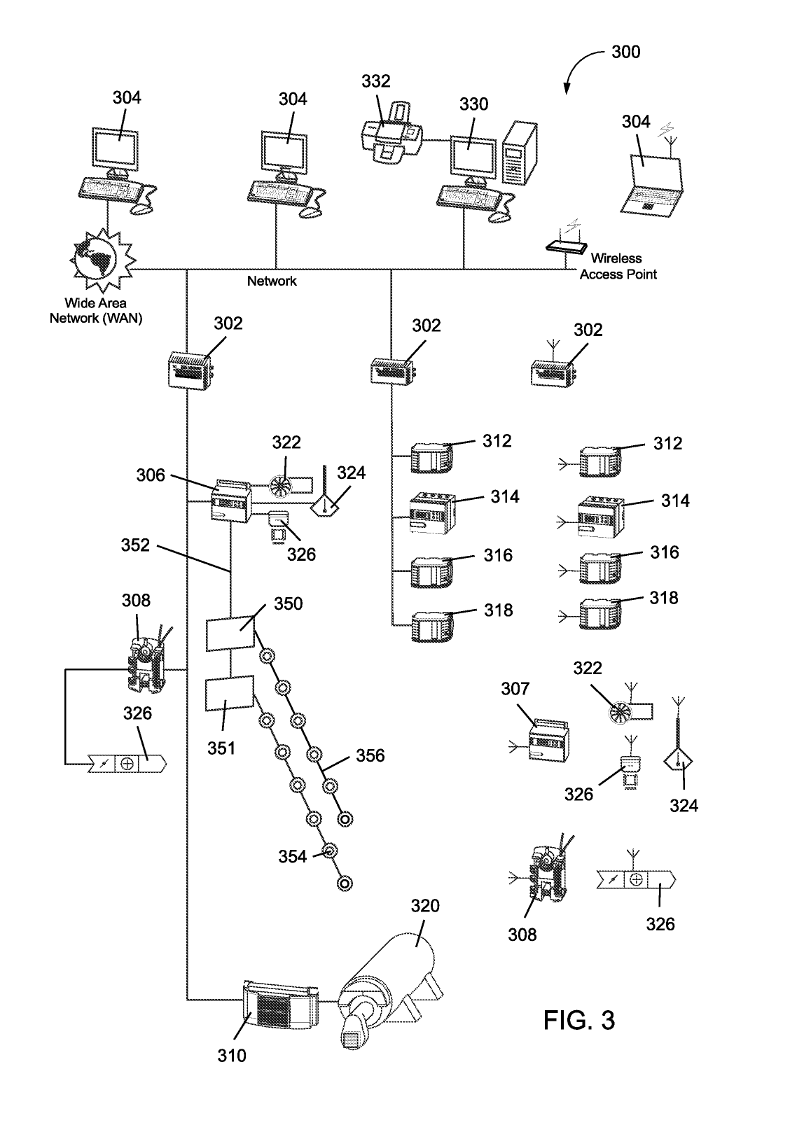

Referring to FIG. 3, a schematic diagram of a BAS 300 is shown, according to an exemplary embodiment. BAS 300 may be a BAS such as the METASYS® brand BAS sold by Johnson Controls, Inc. BAS 300 may include one or more supervisory controllers 302 (e.g., network automation engines (“NAE”)) connected to a proprietary or standard communications network such as an IP network (e.g., Ethernet, WiFi, etc.).

Supervisory controllers 302 monitor and supervise networks of field-level building automation devices that typically control HVAC equipment, lighting, security, fire, and building access. Supervisory controller 302 provides features such as alarm and event management, trending, archiving, energy management, scheduling, dial features, and password protection through its embedded Web-based user interface. Supervisory controller 302 may support various field-level communications protocols and/or technology, including various Internet Protocols (“IP”), BACnet over IP, BACnet Master-Slave/Token-Passing (“MS/TP”), N2 Bus, N2 over Ethernet, Wireless N2, LonWorks, Zigbee, and any number of other standard or proprietary building automation protocols and/or technologies. Supervisory controller 302 may include varying levels of supervisory features and building management features. The user interface of supervisory control 302 may be accessed via a terminal 304 (e.g., a web-browser) capable of communicably connecting to and accessing supervisory controller 302. For example, FIG. 3 shows multiple terminals 304 that may variously connect to supervisory controller 302 or other devices of BAS 300. For example, terminals 304 may access BAS 300 and connected supervisory controllers 302 via a WAN, local IP network, or via a connected wireless access point.

Supervisory controller 302 may be connected to any number of BAS devices. These devices may include, among other devices, devices such as: field equipment controllers (“FEC”) 306, 307 (e.g., field-level control modules), variable air volume modular assemblies (“VMAs”) 308, integrator units 310, room controllers 312 (e.g., variable air volume (“VAV”) devices), unitary devices 316, zone controllers 318 (e.g., air handling unit (“AHU”) controllers), other controllers 314, boilers 320, fan coil units 322, heat pump units 324, unit ventilators 326, expansion modules, “DX” controllers, temperature sensors, motion detectors, other sensors, flow transducers, actuators, dampers, blowers, heaters, air conditioning units, etc. These devices may generally be controlled and/or monitored by supervisory controller 302. Data generated by or available on the various devices that are directly or indirectly connected to supervisory controller 302 may be passed, sent, requested, or read by supervisory controller 302 and/or sent to various other systems or terminals 304 of BAS 300. The data may be stored by supervisory controller 302, processed by supervisory controller 302, transformed by supervisory controller 302, and/or sent to various other systems or terminals 304 of BAS 300. As shown in FIG. 3, the various devices of BAS 300 may be connected to supervisory controller 302 with a wired connection or with a wireless connection.

Supervisory controller 302 may be directly or indirectly coupled to a number of field controllers. Field controller 306 (e.g., such as a FEC2610 sold by Johnson Controls, Inc.) may communicate with field devices via a building automation system field bus 352 such as a SA Bus. BAS field bus 352 may be connected to one or more adapters 350, 351 configured to adapt communications of BAS field bus 352 to a field bus compatible with one or more field devices 354. In FIG. 5, for example, field controller 306 is shown connected via BAS field bus 352 to two adapters 350, 352. Each adapter 350, 352 is shown connected to six field devices 354 (e.g., temperature sensors) via a second field bus 356.

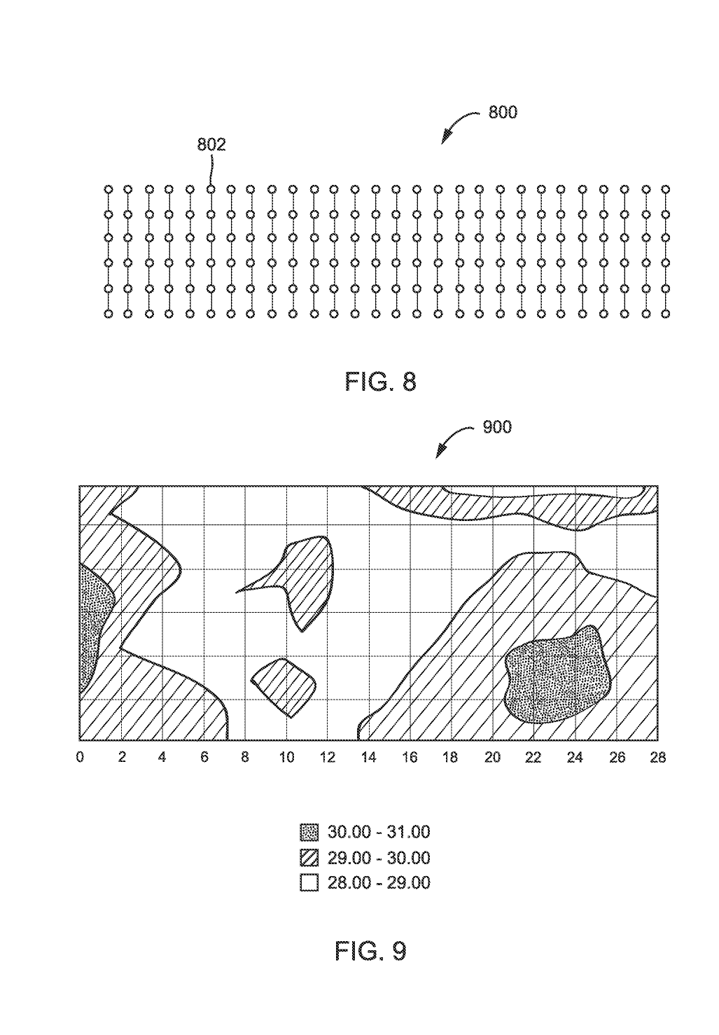

A set of adapters and the adapters' associated sensors may be used to create a large temperature sensing array such as that shown in FIG. 8.

Referring still to FIG. 3, an enterprise server 330 (e.g., an Application and Data Server (“ADS”)) is shown, according to an exemplary embodiment. Enterprise server 330 is a server system that includes a database management system (e.g., a relational database management system, Microsoft SQL Server, SQL Server Express, etc.) and server software (e.g., web server software, application server software, virtual machine runtime environments, etc.) that provide access to data and route commands to BAS 300. For example, enterprise server 330 may serve user interface applications. Enterprise server 330 may also serve applications such as Java applications, messaging applications, trending applications, database applications, etc. According to an exemplary embodiment, the data of various temperature sensor arrays distributed around a zone or a building may be forwarded to enterprise server 330 and compiled to generate, store, provide networked access to, analyze, and/or display temperature map 900 shown in FIG. 9. Enterprise server 330 may store trend data, audit trail messages, alarm messages, event messages, contact information, and/or any number of BAS-related data. Terminals 304 may connect to the enterprise server 330 to access the entire BAS 300, historical data, trend data, alarm data, operator transactions, and any other data associated with BAS 300, its components, or applications. Various local devices such as printers 332 may be attached to components of BAS 300 such as enterprise server 330.

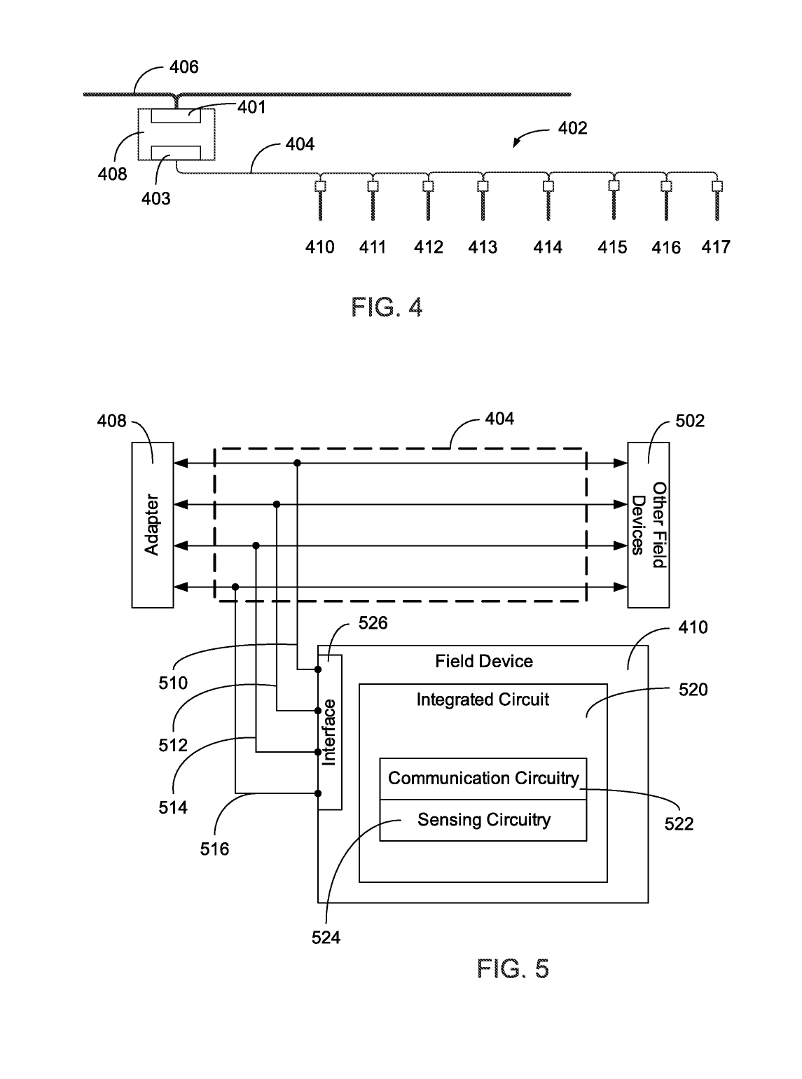

Referring to FIG. 4, a block diagram of a field device array 402 (e.g., a temperature sensor array) utilizing field bus 404 is shown, according to an exemplary embodiment. A BAS field bus 406 is partially shown and is connected to adapter 408. BAS field bus 406 may also be connected to a field controller, other field devices, and/or other adapters. Adapter 408 may serve as translator or gateway between BAS field bus 406 and field bus 404. BAS field bus 406 may include an addressing scheme, with each adapter having an address. The address may be used by the field controller such that the field controller is configured to recognize and communicate with the adapter.

Adapter 408 may act as a gateway and route data sent to or from the field controller to the appropriate field devices 410-417. As shown in FIG. 4, adapter 408 is connected to eight temperature sensors 410-417 of field device array 402 via field bus 404. Adapter 408 is shown to include a first interface 401 for communicating with the field controller. Adapter 408 further includes a second interface 403 for connection with at least one field device located apart from adapter 408. Second interface 403 of adapter 408 may be or include a jack or terminal for a field cable which may be coupled to the at least one field device.

It is important to note that according to various alternative embodiments, interface 401 and/or interface 403 could be wireless interfaces rather than wired interfaces. For example, interface 401 might include a wireless transceiver for communicating with wireless BAS field controller 307 shown in FIG. 3. By way of further example, interface 403 may include a wireless transceiver and communicate with devices 410-417 wirelessly.

Adapter 408 further includes a circuit, microcontroller, and/or processor for adapting the communications from BAS field bus 406 to communications compatible with field devices 410-417. According to an exemplary embodiment, for example, adapter 408 includes a general purpose processor and memory, the memory including computer code for adapting communications of BAS field bus 406 to communications compatible with System Management Bus devices (“SMBus”) devices, and vise versa.

Referring to FIG. 5, a close-up block diagram including field bus 404 suitable for communicating with adapter 408 and field devices 410-417 of FIG. 4 is shown, according to an exemplary embodiment. Field device 410 includes an integrated circuit (“IC”) 520 (e.g., an SMBus compatible IC). Field device 410 further includes an interface 526. Field device 410 may further include a printed circuit (e.g., a PCB), interconnection hardware, decoupling capacitors, pull-up resistors, and DIP switches for addressing.

Integrated circuit 520 is shown to include communications circuitry 522 and sensing circuitry 524. In other words, integrated circuit 520 includes circuitry 522 for communicating on field bus 404 and circuitry 524 for conducting a sensing activity (e.g., measuring, actual sensing, converting a condition to a meaningful value, etc.) on a single chip. The sensing element itself might be integrated with integrated circuit 520 or might be wired to integrated circuit 520. According to an exemplary embodiment, integrated circuit 520 converts signals from the sensing circuitry 524 into signals for the communications circuitry 522. Communications circuitry 522 is configured to send and/or receive signals to and/or from an interface with field bus 404 (e.g., interface 526 between conductors 510-516). Interface 526 may be or include a jack or another terminal, additional communications circuitry (decoupling circuitry, filtering circuitry, etc.). Interface 526 may also be or include a wireless transceiver and/or associated circuitry in accordance with various alternative embodiments.

According to an exemplary embodiment, integrated circuit 520 is designed for chip-to-chip communications (e.g., same circuit board communications) but is used for cable-based communications by providing adapter 408 with increased driving capacity and/or providing cabling having characteristics to support communications from adapter 408 to field device 410. In the embodiment shown in FIG. 5, integrated circuit 520 may be used in a distributed field sensing implementation, using field cable 404 as an interconnection to adapter 408.

According to an exemplary embodiment, integrated circuit 520 is an SMBus IC having a serial interface. SMBus devices may offer significant cost savings over custom-designed circuits or devices as the electronics for supply voltage, line drivers, microprocessors, and sensing components are all fully integrated into one IC. SMBus devices may be small enough to fit inside very small places or having very small housings. For example, SMBus devices may fit inside tubes such as tubes commonly used for temperature probes. A complete end device based on an SMBus integrated circuit may result in a very compact and inexpensive product packaging and wiring. For example, a temperature sensor may be provided in the field by providing a single SMBus compatible integrated circuit. The SMBus specification may be the SMBus Specification published by The System Management Interface Forum.

Field device 410 may be physically connected to BAS field bus 404 via interconnection hardware such as any standard or proprietary interconnection hardware. The conductors 510-516 of field bus 404 may include a positive supply voltage conductor 510, a ground (i.e., negative supply voltage) conductor 512, a data conductor 514 (e.g., a serial data conductor), and a clock conductor 516. Field device 410 may also include a variety of other inputs and/or outputs (e.g., an “Alert” output). One or more of the inputs or outputs of field device 410 may include pull-up resistors and/or decoupling capacitors to conform with the specification of IC 520 of field device 410.

According to an exemplary embodiment, the primary source of power for integrated circuit 520 is received from adapter 408 via field bus 404 (e.g., via voltage conductor 510). According to various alternative embodiments, device 410 includes a local power source (e.g., a battery, a solar panel, etc.) and/or is connected to a local power source.

Small surface-mount switches such as DIP switches may exist on field device 410 and may be used for addressing or setting purposes. According to other various embodiments, addresses may be fixed (resulting, for example, in a model or device for each address). In addition to or as an alternative to the SMBus specification, other board-to-board specifications may be adapted for use with BAS field bus 404 such that an adapter device may remotely control or drive one or more end devices originally meant exclusively for board-to-board communications.

According to an exemplary embodiment, the cable for field bus 404 may be selected to have the following characteristics: (1) a sufficiently low DC resistance to allow a desired cable length (e.g., 3-500 ft); (2) sufficiently low line-to-line capacitances to ensure that signal and clock distortion are acceptably low; and (3) sufficient shielding to maintain sufficiently low clock-to-signal coupling and electro-magnetic interference. According to an exemplary embodiment, the cable for field bus 404 is at least three feet in length, allowing for the field device to be located remotely from the adapter (or other supervisory controller driving the cable) and to be at least somewhat mobile or capable of free positioning relative to the adapter.

Field bus 404 may include junctions, jacks, terminals, or other features so that other field devices 502 (e.g., field devices 410-417) may be coupled to adapter 408.

According to an exemplary embodiment, adapter 408 may include a wireless transceiver for wireless communication with a supervisory controller (e.g., controller 306) and/or a field bus interface (e.g., wired, Ethernet, optical) for wired communication with a supervisory controller (e.g., controller 306).

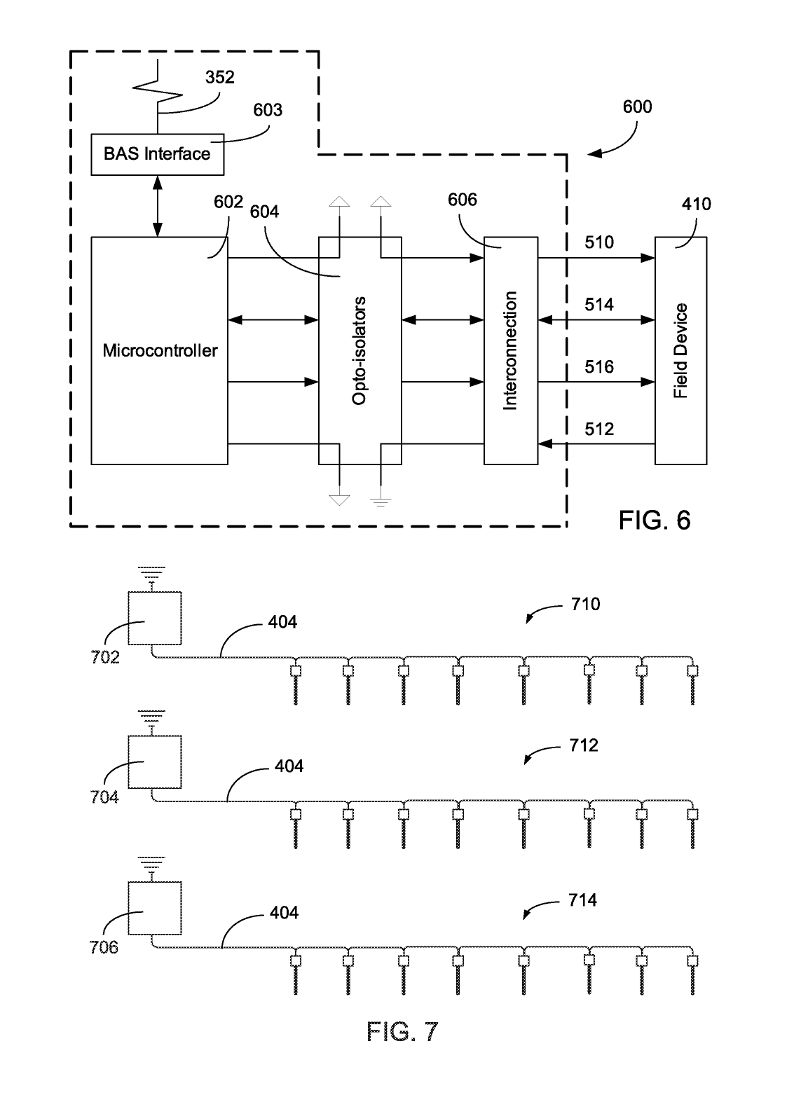

Referring to FIG. 6, a master device or controller 600 is shown, according to an exemplary embodiment. Master device 600 may be implemented in a field controller, in an adapter, or in a first end node or sensing node. Master device 600 includes a microcontroller 602. Microcontroller 602 may be dedicated or shared. Microcontroller 602, for example, may be a dedicated IC or SMBus microcontroller configured to adapt communications of a BAS field bus (e.g., a conventional SA bus) to communications compatible with attached SMBus compatible field devices. According to various exemplary embodiments, microcontroller 602 may be or include an application specific integrated circuit, a field programmable gate array, a circuit having a general purpose processor and memory including computer code (the computer code for adapting communications from the SMBus compatible field devices to the BAS field bus, etc.). According to an exemplary embodiment, microcontroller 602 is a master device microcontroller according to the SMBus specification and field device 410 is a slave device according to the SMBus specification.

According to the exemplary embodiment shown in FIG. 6, master device 600 includes opto-isolators 604 disposed between microcontroller 602 and interconnection structures 606. Opto-isolators 604 may be configured to act on one or more of the signal, clock, and/or power lines of microcontroller 602. Opto-isolators 604 may be used to isolate the low current field devices (e.g., field device 410) from undesirable voltage spikes, ground loops, and the like. Interconnection structures 606 may be any number of jacks, terminals, solder points, or other suitable interfaces for connecting a field bus cable (e.g., conductors 510-512) to master device 600.

Master device 600 is further shown to include BAS interface 603 communicably coupled to microcontroller 602. BAS interface 603 is configured to send and/or receive communications on BAS field bus 352. BAS interface 603 may be any wired or wireless interface (e.g., including an RF transceiver or optical transceiver) configured for communications compatible with protocols of the BAS and/or BAS field bus 352.

Referring to FIG. 7, a series of wireless adapters 702-706 are shown, according to an exemplary embodiment. Adapters 702-706 may include a wireless transceiver for communicating with a field controller and/or another supervisory controller. Each adapter 702-706 may also be coupled to a sensor array 710-714. Adapters 702-706 may utilize any number of wireless technologies (e.g., WiFi, BlueTooth, Zigbee, IEEE 802.11, 802.15, etc.) and may also operate with systems having some wired adapters. Adapters 702-706 may convert wireless input or output signals to field bus compatible signals (e.g., SMBus signals) and/or vice versa. Adapters 702-706 may include a microcontroller such as microcontroller 602 of FIG. 6.

### Field Devices in a Sensing Array

Referring to FIGS. 8 and 9, a block diagram of a temperature sensor array 800 (FIG. 8) of a highly monitored zone and a resulting temperature map 900 (FIG. 9) that may be generated using data retrieved from array 800 are shown, according to an exemplary embodiment. According to other exemplary embodiments, sensor array 800 and temperature map 900 may be another type of sensor array and map (e.g. humidity, pressure, motion, etc.). In environments where detailed and accurate temperature sensing and correction are desirable (e.g., pharmaceutical warehousing), a temperature map may be developed to provide detailed information regarding the temperature distribution within a given zone. For example, in a pharmaceutical warehouse, where the stored material may be highly susceptible to heat, it is often desirable to know detailed information about the temperature of various portions of an area rather than merely the average temperature of the entire area. A temperature map may allow building controls personnel to determine whether or not a condition has caused any undesirable temperature pockets or localized conditions. These pockets may be due, for example, to uneven amounts of sunlight hitting one side of the building, inadequate ventilation, a lighting condition, a draft, etc.

A sensor array of a large building zone may include a large number of sensors distributed around the zone. In FIG. 8, for example, twenty eight sensor columns 802 having six sensors are shown in sensor array 800. The data sensed by sensor array 800 may be represented on a temperature sensor map such as map 900 of in FIG. 9. According to various exemplary embodiments, the devices and/or building automation field bus described in the present application may be used to implement sensor array 800. For example, supervisory controller 302 may receive sensor data from devices 354 and may include a processor and computer code in memory for generating the temperature sensor map based on the received sensor data.

Temperature map 900 is mapped to the sensor columns of sensor array 800. In map 900 of FIG. 9, the x-axis represents the width of sensor array 800 while the y-axis represents the depth of each column of array 800 (e.g., six sensors deep as illustrated in FIG. 8). Temperature map 900 may “blend” the various temperature readings together based on averaging the various temperature readings from the sensor (e.g., creating bands or regions of temperature). The various temperature readings at specific locations may be used to predict the temperature value at “in-between” spots (e.g., locations in between two sensors where the temperature may be different than at the two sensor locations). For example, in map 900, three temperature ranges are illustrated.

According to an exemplary embodiment, a system for providing the temperature sensor array and map of FIGS. 8 and 9 includes a plurality of adapters (e.g., adapter 408 shown in FIGS. 4-5). Each adapter is configured to convert a communications protocol for the attached temperature sensors to a communications protocol compatible with a building automation system field controller (or supervisory controller). The communications protocol for the attached temperature sensors may be a protocol according to a specification, such as the SMBus specification, with the adapters including microcontrollers configured to serve as master devices according to the specification. The temperature sensors may be configured to be powered by the adapters and connected via field bus cables to the adapters. A supervisory controller upstream from the building automation system field controller is configured to receive signals from the building automation system field controller relating to the temperature sensors. The supervisory controller is configured to generate a graphical temperature map for display, storage, on-line viewing, and/or printing. According to an exemplary embodiment, the temperature sensors include an integrated circuit having both temperature sensing circuitry and communications circuitry.

While various embodiments are illustrated in the figures and described herein, it should be understood that the embodiments are offered by way of example only. The present disclosure is not limited to a particular embodiment, but extends to various modifications that nevertheless fall within the scope of the appended claims.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system.

The construction and arrangement of the devices, components, sensors, adapters, and field bus elements as shown in the various exemplary embodiments are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the exemplary embodiments without departing from the scope of the present disclosure.

What is claimed is:

1. A field device for communicating with a building automation system field controller via a field cable, comprising:
an integrated circuit comprising communications circuitry and sensing circuitry, the integrated circuit configured to convert a first signal from the sensing circuitry to a second signal compatible with the communications circuitry; and
an interface configured to communicatively couple the field cable to the communications circuitry.

2. The field device of claim 1, wherein power for the integrated circuit is received via the field cable.

3. The field device of claim 1 further comprising a battery configured to provide power to the integrated circuit.

4. The field device of claim 1, wherein the integrated circuit is a System Management Bus (SMBus) compatible integrated circuit.

5. The field device of claim 1, wherein the field cable comprises a four conductor cable having a length of at least three feet.

6. The field device of claim 1, wherein the integrated circuit is configured for chip-to-chip communications via an integrated circuit bus.

7. A sensing system for use with a building automation system field controller, comprising:
a device comprising an integrated circuit comprising communications circuitry and sensing circuitry, the integrated circuit configured to convert a first signal from the sensing circuitry to a second signal compatible with the communications circuitry; and
an adapter physically separate from the device, the device and the adapter configured for interconnection via a field cable;
wherein the adapter is configured to bridge communications between the building automation system field controller and the device.

8. The sensing system of claim 7, wherein the adapter includes a wireless transceiver for communicating with the building automation system field controller.

9. The sensing system of claim 7, wherein the adapter includes a wired field bus interface for communicating with the building automation system field controller.

10. The sensing system of claim 7, wherein the integrated circuit is compatible with the System Management Bus (SMBus) specification.

11. The sensing system of claim 7, wherein the adapter is configured to provide power to the device via the field cable.

12. A communications adapter for facilitating communication in a building automation system between a supervisory controller and a plurality of field devices, the adapter comprising:
a first interface for communicating with the supervisory controller according to a first communications protocol;
a second interface for communicating with a plurality of field devices via a wired bus according to a second communications protocol; and
a microcontroller for converting a first signal received at the second interface and according to the second communications protocol to a second signal for providing to the first interface;
wherein the second interface and the second communications protocol are compatible with a System Management Bus (SMBus) specification.

13. The communications adapter of claim 12, wherein the second interface is configured to provide power to the plurality of field devices via the wired bus.

14. The communications adapter of claim 12, wherein the wired bus is a cable at least three feet in length.

15. The communications adapter of claim 12, wherein the microcontroller is a master device according to the SMBus specification.

16. The communications adapter of claim 12, wherein the first interface further comprises a radio frequency transceiver.

17. The communications adapter of claim 12, wherein the microcontroller is a master device according to the SMBus specification.

18. A temperature sensor system for use with a building automation system field controller, the temperature sensor system comprising:
a first adapter configured to convert a second communications protocol to a first communications protocol, the first communications protocol compatible with the building automation system field controller, the second communications protocol according to a specification, the first adapter comprising a microcontroller suitable for serving as a master device according to the specification; and
a first set of temperature sensors configured to be powered by the adapter and connected via a first cable to the first adapter.

19. The temperature sensor system of claim 18, wherein the microcontroller is configured to drive the first set of temperature sensors configured to be located remotely from the first adapter and wherein the cable is configured to be compatible with the second protocol.

20. The temperature sensor system of claim 18, further comprising:
a second set of temperature sensors configured to be powered by a second adapter and connected via a second cable to the second adapter; and
a supervisory controller configured to receive signals from the building automation system field controller relating to the first set of temperature sensors and the second set of temperature sensors, the supervisory controller configured to generate a graphical temperature map for display, storage, on-line viewing, and/or printing.

21. The temperature sensor system of claim 20, wherein each of the first set of temperature sensors includes an integrated circuit comprising temperature sensing circuitry and communications circuitry.
